(19) United States
(12) Patent Application Publication
(10) Pub. No.: US 2007/0227917 A1
(43) Pub. Date: Oct. 4, 2007

(54) METHOD OF FORMING DENTAL RESTORATIVE MATERIAL PACKAGING

(75) Inventor: Kevin D. Foust, Dana Point, CA (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/761,436

(22) Filed: Jun. 12, 2007

Related U.S. Application Data
(62) Division of application No. 10/664,054, filed on Sep. 15, 2003.

(51) Int. Cl. B65C 3/00; A61C 3/00; B65D 83/76; B65D 85/00

(52) U.S. Cl. 206/63.5

(57) ABSTRACT

A method of forming a capsule assembly which includes radiation-reactive dental restorative material includes exposing selected portions of an exterior surface of the container to laser generated radiation at an energy level sufficient to create indicia on the exterior surface, with the indicia having a sufficient contrast relative to the exterior surface to enable readily visual human and/or optical machine-readable detection of the indicia. The indicia identify characteristics of the radiation-reactive dental restorative material in the container, the container is formed from a laser-enhanced (LE) polymer which is inert relative to the radiation-reactive dental restorative material within the container. The ability of the container to dispense the radiation-reactive dental restorative material under pressure is not adversely affected by the exposure of the container to laser generated radiation when creating the indicia on the exterior surface of the container. Optionally, the exposure of the laser-enhanced (LE) polymer to laser generated radiation is done at an energy level sufficient to create one or more raised protrusions on the container, useful for engaging a resilient cap adjacent an orifice on the container.

### CROSS-REFERENCE TO RELATED APPLICATION(S)

None.

### FIELD

This invention relates to a method of forming a capsule assembly which identifies and includes a radiation-reactive dental restorative material. In another aspect, the invention relates to a method of assembling two component parts wherein exposure of an exterior surface of one part to laser generated radiation creates a protrusion thereon useful for engagement with the second part.

### BACKGROUND OF THE INVENTION

Lasers are in widespread use for marking a variety of articles. Common examples of laser engraved articles include trophies, signs, sporting goods and awards. Other laser engraved articles include product containers, musical instruments and woodcrafts.

Product containers often bear a number of identification marks that serve various purposes. Product containers commonly include at least the name of the product as well as the name of the manufacturer or seller of the product. If the nature of the product is not readily apparent, the container may also include identification marks written as text that describe in generic terms the type of product within the container.

In many instances, product containers also include a number of additional identification marks that serve other purposes. For example, the container may have marks that describe the color, shape, size, weight or volume of the product. It is also common for product containers to bear marks that identify the manufacturer's or seller's address, or country of origin of the product.

Many product containers also include additional identification marks that convey other information as well. For example, identification marks on product containers may include serial numbers or batch or lot codes that help identify, among other things, more detailed information to the manufacturer regarding the manufacturing process for the particular product within the container. Furthermore, identification marks on product containers may include letters or numbers that serve as catalog or product numbers for the product.

In the past, identification marks have frequently been applied to product containers using ink printing technology of one sort or another. In some instances, ink markings are applied to a label such as a label made from a section of paper or plastic film having an adhesive coating on its back side. The label is often applied to the container after the label is marked.

In other instances, ink printing technology is used to apply an ink identification mark directly on an exterior surface of the container. In that instance, the color of the ink is often selected to contrast with the color of the exterior surface of the container in order to enhance the visibility of the resulting identification mark. The identification mark may be formed as a positive image of the ink (i.e., where the ink creates letters, symbols or other indicia for identification) or as a negative image (such that the lack of ink, and hence the underlying exterior surface of the container, creates the letters, numbers or other indicia).

However, certain problems have long been associated with ink printing. For example, the operator must ensure that a sufficient quantity of fresh ink is available at all times. Also, the operator must ensure that the ink has properly hardened or cured after application so that the mark is not smudged or otherwise harmed during subsequent handling. Moreover, and particularly with ink pad printing technology, there is often a certain amount of labor, time and expense associated with efforts to switch from one identification mark to another.

Ink printing has been used on dental articles, such as containers (e.g., capsules or cartridges) for dental pastes. Both pad printing and thermal transfer printing techniques have been employed. However, pad printing is expensive and difficult to control in terms of marked position and quality. Typical pad printing location control operates in the process capability range of 0.6 Cpk. In addition, pad printing is a print-plate and ink based process that requires significant lead time to change the information being printed, and it is a solvent-based process that thus presents environmental concerns. While not a solvent-based process, thermal transfer printing has many of the same disadvantages as pad printing.

In recent years, laser technology has been used to engrave product identification marks directly on product containers. Laser engraving technology presents an important advantage over ink printing technology, in that the laser engraving apparatus enables the operator to easily switch from one identification mark to another. For example, the laser engraving apparatus may include a controller that directs movement of the laser beam. In that instance, a change in the identification mark is carried out by simply changing a set of computer instructions used by the controller to determine the path of the beam.

However, laser engraved identification marks on product containers are sometimes difficult to see. The ease of visibility of the mark depends on many factors, including the width of the mark, the color of the underlying container surface, and the material or coating thereon being marked. The operator must also exercise caution to ensure that the energy of the beam on the surface of the container is not sufficient to burn through or otherwise unduly weaken the container, so that the strength of the container is not significantly impaired.

Known identification marks, including the marks described above, are somewhat satisfactory and are in widespread use. However, there is a continuing need to improve the state of the art. In particular, it would be desirable to provide an identification mark that is extremely easy to read, and yet is also durable and relatively inexpensive to manufacture even when a relatively large amount of information is to be conveyed.

Laser engraved identification marks have been used on dental articles, such as polymer containers (e.g., capsules or cartridges) for dental restorative materials. However, those marks have been difficult to see when applied directly to the container itself. The use of ink coatings which are then laser engraved may offer some improvement in visibility on such a container, but requires the additional step of ink printing on the container, along with its associated problems. Some dental product containers, such as cartridges for dental pastes, have nozzles or nipples which have flexible caps mounted thereon for storage and sealing of the dental paste material therein. In processing, transportation and use, those caps are sometimes dislodged from the nozzle or nipple, thereby exposing the dental paste in the cartridge to ambient conditions prior to use, which can have detrimental effects on those dental pastes.

### SUMMARY OF THE INVENTION

In one aspect, the present invention is a method of forming a capsule assembly which includes radiation-active dental restorative material which comprises providing a container having an exterior surface and an interior chamber, wherein the container is formed from a laser-enhanced polymer and formed to inhibit the transmission of light radiation of selective wavelengths therethrough. The method includes exposing select portions of the exterior surface of the container to laser generated radiation at an energy level sufficient to create indicia on the exterior surface, with the indicia having a sufficient contrast relative to the exterior surface to enable readily visible human and/or optical machine-readable detection of the indicia. The method further includes inserting radiation-reactive dental restorative material into the interior chamber of the container. The indicia, at least in part, identify characteristics of the radiation-reactive dental restorative material within the container. The laser-enhanced polymer forming the container is inert relative to the radiation-reactive dental restorative material within the container. The ability of the container to dispense the radiation-reactive dental restorative material under pressure is not adversely affected by the exposure of the container to laser generated radiation when creating the indicia on the exterior surface of the container.

In another aspect, the present invention is a method of forming a capsule assembly which includes radiation-reactive dental restorative material which comprises providing a container having an exterior surface and an interior chamber, wherein the container is formed from a laser-enhanced polymer and formed to inhibit the transmission of light radiation of select wavelengths therethrough. The container has a first open end and a second end with a discharge nipple thereon, with the discharge nipple having an orifice therethrough in communication with the interior chamber of the container. The method includes exposing selected portions of the exterior surface on the discharge nipple to laser generated radiation at an energy level sufficient to create a raised protrusion on the discharge nipple. The method further includes inserting radiation-reactive dental restorative material into the interior chamber of the container through the first open end of the container, sealing the first open end of the container, and mounting a removable cap over the discharge nipple. The cap is flexible to cover and seal the orifice, and the cap engages the protrusion on the discharge nipple to inhibit inadvertent separation of the cap from the discharge nipple.

In another aspect, the present invention is a method of assembling two component parts which comprises providing a first component part (which is elongated, has an orifice therethrough, has an exterior surface extending about the orifice, and is formed from a laser-enhanced polymer) and providing a second component part (which is formed to resiliently extend over the elongated portion of the first component part bearing the orifice). The method includes exposing the exterior surface of the first component part to laser generated radiation at an energy level sufficient to create a protrusion thereon, and resiliently expanding the second component part over the exterior surface and protrusion on the first component part to cover and seal the orifice thereof, with the protrusion on the first component part engaging the second component part to inhibit inadvertent separation of the two component parts.

### BRIEF DESCRIPTION OF THE DRAWINGS

FIG. 1 is a perspective view of a container which is adaptable for use in connection with the present invention, wherein the container in this instance is a disposable cartridge for storing and dispensing a quantity of dental restorative material.

FIG. 2 is a sectional view as taken along lines 2-2 in FIG. 1, but also including a removable cap over the discharge nipple of the cartridge.

FIG. 3 is a side elevational view of the cartridge (with cap removed) showing exemplary laser marked identification indicia thereon.

FIG. 4 is a top view of a second embodiment of a container in the form of a dental restorative material cartridge (with cap removed) showing laser generated protrusions on its discharge nipple.

FIG. 5 is an enlarged nipple end view of the cartridge of FIG. 4.

FIG. 6 is an enlarged partial sectional view of the nipple end of the cartridge of FIG. 4, as taken along lines 6-6 in FIG. 5, with a removable cap in place over the discharge nipple of the cartridge.

While the above-identified drawings set forth several embodiments of the invention, other embodiments are also contemplated, as noted in the discussion. In all cases, this disclosure presents the invention by way of representation and not limitation. It should be understood that numerous other modifications and embodiments can be devised by those skilled in the art which fall within the scope and spirit of the principals of this invention. The figures may not be drawn to scale. Like reference numbers have been used throughout the figures to denote like parts.

### DETAILED DESCRIPTION

The present invention relates to forming a capsule assembly for storing and dispensing radiation-reactive dental restorative materials. Such dental compositions include restoratives, cements (e.g., luting cements, orthodontic cements), etching gels, adhesives, glass ionomer cements, sealants, and the like. Such dental compositions often include light-curable non-toxic pastes that contain a photoinitiator and a dental filler dispersed in a resin. Resins useful in such a dental composition are hardenable organic compositions having sufficient strength, hydrolytic stability, and non-toxicity to render them suitable for use in the mouth. Examples of such resins include polymerizable acrylate, methacrylate, urethane, and epoxy resins. Mixtures and derivatives of such resins are also useful. A typical dental restorative composition or material includes one or more radiation-reactive (i.e., light radiation curable) acrylate and/or methacrylate component, a filler, and a photoinitiator system (e.g., including a photoinitiator or sensitizer compound such as camphorquinone and an electron-donor compound). Commercial examples of radiation-reactive dental restorative materials include Z100 Restorative, Filtek Z250 Universal Restorative, and Filtek Supreme Universal Restorative, all available from 3M Company, St. Paul, Minn.

In connection with the inventive method, the capsule assembly is formed from a container made of a laser-enhanced polymer. In this case, a laser-enhanced (LE) polymer is a thermoplastic polymer blend comprising a resin (i.e. base polymer or base resin) and one or more laser-enhancing additive components selected such that, following injection molding into an article, an exterior surface of the molded article can be laser marked to provide a marking that has a greater contrast with the article's exterior surface than a corresponding laser marking on the exterior surface of an injection molded article made from the same resin, but lacking the one or more laser-enhancing additive components. The base thermoplastic polymer may be, for example, a polyamide (such as a nylon polymer), a polyester, a polyolefin (such as a polypropylene), a polycarbonate, and mixtures thereof. A preferred base resin for the present invention is nylon 6/6. The additive components might include inorganic fillers (e.g., mica, carbon black, titanium dioxide, and kaolin) or colorants (e.g., pigments), flame retardants, UV inhibitors, or stabilizers which have the effect of improving absorption of laser light radiation. Sources for such laser-enhanced polymers, suitable for medical and dental use, include RTP Company, Winona, Minn.; Clariant Masterbatches Div., Albion, Mich.; PolyOne Corp., Suwanee, Ga.; and Ticona, Summit, N.J.

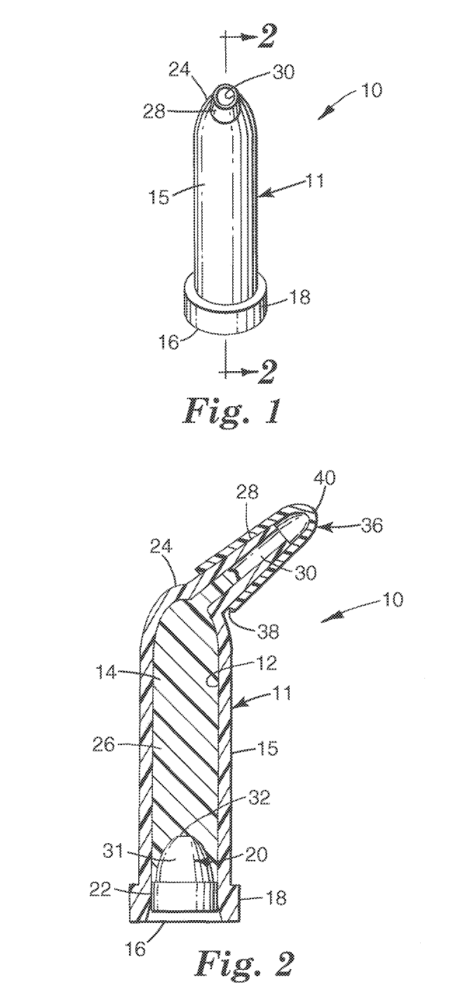

FIGS. 1 and 2 illustrate one embodiment of a dental restorative material container or cartridge 10 of the present invention. Referring to FIG. 2, the illustrated cartridge 10 comprises a generally cylindrical body 11 with a generally cylindrical inner wall 12 defining an elongate interior chamber 14. The body 11 has an exterior surface 15, and has an open end 16 with an adjacent annular flange 18 useful for detachably mounting the cartridge 10 in an ejector-type gun (not shown).

A displaceable piston 20 is inserted in the open end 16. A sidewall 22 of the piston 20 is in the form of a flange about the circumference of the piston 20 and is in sealing conformance with the inner wall 12. The piston 20 serves to seal the open end 16 of the cartridge 10 during storage in order to prevent exposure of an enclosed dental material (i.e., composition) 26 to air. The piston 20 can be displaced toward a discharge end 24 of the body 10 by means such as a conventional handheld, manually powered, air powered, or motor powered ejector-type gun. When the piston 20 is displaced toward the discharge end 24, the dental composition 26 is forced under pressure from a discharge nipple 28 (which extends from the discharge end 24) and has a discharge orifice 30 through which the dental composition 26 is discharged. The piston 20 has a bullet-shaped head 31 with a flattened end 32. The discharge orifice 30 can be sealed with a removable cap 36, which serves to seal the discharge end 24 of the cartridge 10 during storage and transport. The cap 36 is formed from a flexible material in a generally tubular shape with an open end 38 and a closed end 40. The cap 36 stretches as it is inserted onto the discharge nipple 28 to create an effective seal over the orifice 30, thereby closing off the dental composition 26 from ambient conditions. When the dental composition 26 is to be discharged, the cap 36 is removed from the discharge nipple 28.

A dental restorative material cartridge is typically relatively small, and is intended to contain an amount of a dental composition that can be substantially fully expended during the course of a single procedure or several (e.g., two to about ten) procedures. The volume of the interior chamber (as measured by the volume displaced by the piston's travel) is therefore preferably from about 0. 1 ml to about 3 ml, more preferably from about 0.3 ml to about 1 ml. The cross-sectional area of the interior chamber in the plane normal to the longitudinal axis of the interior chamber is relatively small, preferably less than or equal to about 50 mm², more preferably less than or equal to about 40 mm² and most preferably less than or equal to about 20 mm².

The wall thickness of such a cartridge is such that it will withstand the pressures exerted during extrusion of a dental relatively viscous composition at a useful rate without bursting or excessive yielding. The wall thickness will vary based on several factors, such as the viscosity of the dental composition, the tensile strength of the material from which a cartridge is made, the dimensions of the inner chamber (e.g., length, shape, and cross-sectional area), and the size of the orifice in the discharge nipple. As the cartridge is intended primarily for use in dispensing small amounts of a dental composition to a particular area of the mouth, it is preferred that the orifice in the discharge end be relatively small so as to deliver a controlled amount of dental composition that can be placed with precision. Accordingly, the orifice preferably has a cross-sectional area of less than or equal to about 2 mm², more preferably less than or equal to about 1 mm². Particular dimensions for various embodiments will be easily determined by those skilled in the art. For the particular cartridge embodiment illustrated in FIGS. 1 and 2, the inside diameter of the interior chamber 14 is preferably from about 2 mm to about 7 mm, more preferably from about 3 mm to about 5 mm. The length of the body 11 is preferably from about 2 cm to about 8 cm, more preferably from about 2 cm to about 4 cm. The discharge nipple 28 can be of any suitable length, e.g., 1 cm, and the discharge orifice 30 in the discharge nipple 28 is preferably circular, about 1 mm in diameter.

Because the dental compositions stored in cartridges such as described above are often light-curable materials, the cartridge must be opaque to actinic radiation. Forming the cartridge from a black material, of course, satisfies this criteria, but other opaque characteristics are suitable, so long as the cartridge is formed to inhibit the transmission of light radiation of the wavelengths which would serve to initiate curing of the dental composition stored therein. For instance, one photoinitiator (i.e., sensitizer) useful for such dental compositions is CPQ (camphorquinone) which has an absorbance peak of 470 nm. Thus, when CPQ is used, radiation wavelengths from 400 to 500 nm should be blocked, and more preferably, wavelengths from 370 to 530 nm should be blocked. Further, the material forming the cartridge must be inert relative to the dental composition stored therein, and must be non-toxic to render it suitable for use in the mouth. Such cartridges are typically made by injection molding.

While the embodiment illustrated in FIGS. 1 and 2 represents one configuration of a cartridge formed in connection with this invention, those skilled in the art will recognize that the particular configuration of the cartridge is not unduly critical to this invention. Other configurations are suitable. For example, while the discharge nipple may be integral with the body of the cartridge, embodiments wherein the discharge end of the cartridge is adapted in the manner of a LUER-LOK tip, a friction fit tip, a bayonet type fitting, or a screw-on tip are suitable. Further, while the discharge nipple may be sealed with a removable cap, the nipple may be closed by ultrasonic bonding or spin welding and opened by mechanical means (e.g., cutting), or the like. Likewise, while the discharge orifice may open into a discharge nipple that is angularly disposed to the longitudinal axis of the body, embodiments wherein the discharge nipple is not angularly disposed are suitable as well. Also, the illustrated piston configuration is particularly useful because the portion of the dental composition that has been in the vicinity of the piston throughout the period of storage (and therefore is more susceptible to the adverse effects of any absorption into or passage through the piston, and leakage at the piston/inner wall junction) is not extruded from the cartridge. It also offers less potential for the degradation of a dental composition by shear forces during extrusion. However, embodiments wherein the piston head is closely complementary to the inner surface of the discharge end are suitable. The inner wall can define an interior chamber of any suitable cross-sectional shape in the plane normal to its longitudinal axis (e.g., a circle, ellipse, polygon, or the like), and the open end can be adapted in any suitable manner to be detachably mounted in a hand-held ejector-type gun. Additional aspects of such a container are described in U.S. Pat. No. 5,100,320 (Martin et al.) and U.S. Pat. No. 5,624,260 (Wilcox et al.) and in International Application Publication No. WO 01/4559 A1 (Peterson), which are incorporated by reference herein.

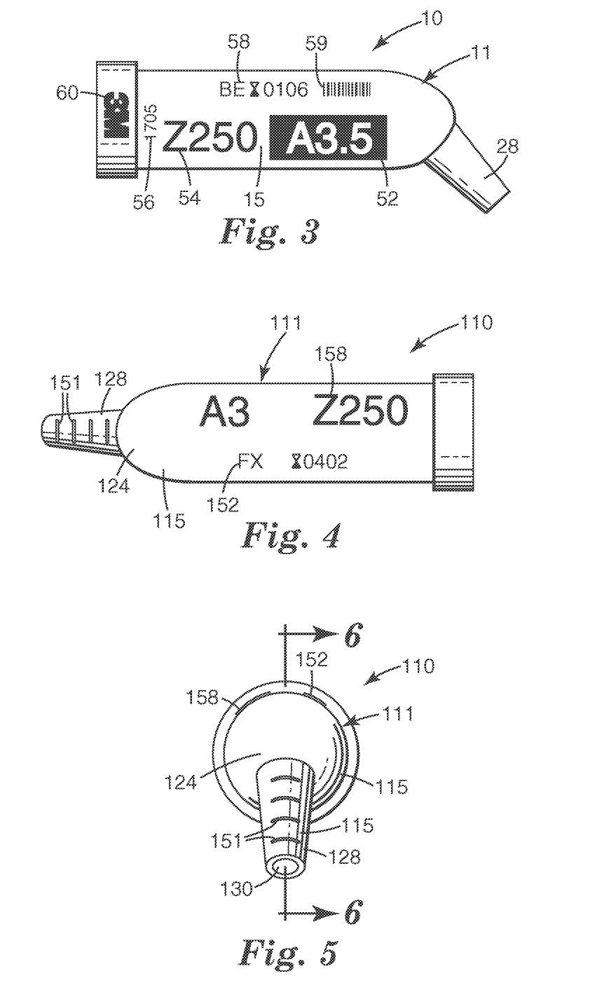

FIG. 3 illustrates the cartridge 10 having laser generated identification marks 52, 54, 56, 58, 59 and 60 on the exterior surface 15 thereof. In some cases, the indicia are positive indicia (e.g., indicia 54, 56, 58, 59 and 60), while in other cases, the laser affects the “background” so that the indicia are presented in a negative format (e.g., indicia 52). The indicia are formed by exposing the exterior surface 15 of the cartridge 10 to laser generated radiation (i.e., a laser beam) at an energy level sufficient to causing foaming of selected portions of the exterior surface 15. The laser beam is moved as needed to create the desired letters, numerals, symbols or reverse images thereof. While all of the indicia may be specific to a particular cartridge and the characteristics of the dental material therein, one mark (such as mark 54) may be a genus identification mark, while another mark (such as mark 52) may be a species identification mark. A third mark may constitute source identification information (such as mark 60) while other marks (such as marks 56 and 58) may indicate other characteristics of the dental material contained within the cartridge 10 (e.g., a color or shade of the material, lot number, batch number, date, etc.). The indicia may comprise machine-readable indicia such as a bar code (e.g., mark 59). Each indicia placed on the exterior surface of the cartridge 10 has a sufficient contrast relative to the exterior surface of the cartridge 10 to enable readily visual human detection of the indicia and/or optical machine-readable detection of the indicia. Those portions of the exterior surface 15 of the cartridge 10 which are exposed to the laser generated radiation change color (e.g., from black to white). This is possible because of the use of a laser-enhanced polymer as the material for the body 11 of the cartridge 10, and the parameters for exposure of the laser radiation to the cartridge 10. Such laser process parameters include laser speed, laser power, and laser frequency, with typical values used to mark various articles molded from laser-enhanced and non-laser-enhanced polymers provided in Table 1 of the Examples section.

The indicia are formed by a foaming process of the cartridge material initiated by its exposure to the laser generated radiation. The indicia, once formed, are raised relative to the exterior surface 15 to readily enable manual tactile detection thereof. For instance, the indicia may be raised about 1.5 mil (0.04 mm) in height from the exterior surface 15 (as opposed to typical laser engraving, where the laser marking is engraved approximately 1 mil (0.027 mm) below the surface). The raised indicia are particularly advantageous on small articles, such as the exemplary dental material cartridges, in order to facilitate non-slip handing thereof (which often will take place with gloves on, thereby further hindering the user's tactile senses and handling abilities). Once formed, the indicia are as durable as the base material of the cartridge and is, for all practical purposes, indelible.

The use of a laser-enhanced (LE) polymer results in the ability to attain an extremely effective contrast between the indicia and the container being marked. The indicia are thus readily detectible for providing information, either visually or via optical machine-readable techniques. The relative contrast (of indicia to background surface bearing the indicia) can be quantified by a Brightness Scaled Contrast number according to the following formula:
Brightness Scaled Contrast=(Luminosity/Indicia−Luminosity/Background)×(Luminosity/Indicia)÷(Luminosity/Indicia+Luminosity/Background)
In one embodiment, a Brightness Scaled Contrast number of at least 50 is preferred, and more preferably at least 100, and even more preferably at least 150.

An example of a suitable laser system for creating such markings is a Nd:YAG sold under the brand name “Hi-Mark” No. 400 from GSI Lumonics, Inc., Kanata, Ontario, Canada). However, other laser systems such as CO₂ lasers and masers may also be employed. The indicia may be made in one or two passes of the laser beam, or additional passes if a somewhat wider indicia field is desired. Multiple laser beam passes may also be used, either from multiple lasers or via laser beam splitting and focusing techniques.

The settings of the laser system are selected so that the laser-enhanced polymer is foamed on the exterior surface 15 as described above, but so that underlying portions of the cartridge 10 are not unduly heated or softened. It is important that the structural integrity of the body 11 of the cartridge 10 be maintained since the dental composition 26 therein will ultimately be pressurized for dispensing through the discharge nipple 28. The ability of the cartridge 10 to dispense the dental composition 26 under pressure must not be adversely affected by the exposure of the cartridge 10 to the laser generated radiation when the indicia are created on the exterior surface 15 thereof.

Depending upon the size of the container being marked and the laser system involved, it may be possible to mark a plurality of containers in one pass of the laser. In other words, a plurality of containers (e.g., five) may be aligned in a fixture as a set and then marked during a single run or pass of a laser beam thereover. Selected portions of the exterior surfaces of each of the containers in that set are thus exposed to laser generated radiation to create the desired indicia on each container. In one embodiment, different indicia can be created on different containers in that set while those containers are being exposed to the laser generated radiation during a single pass.

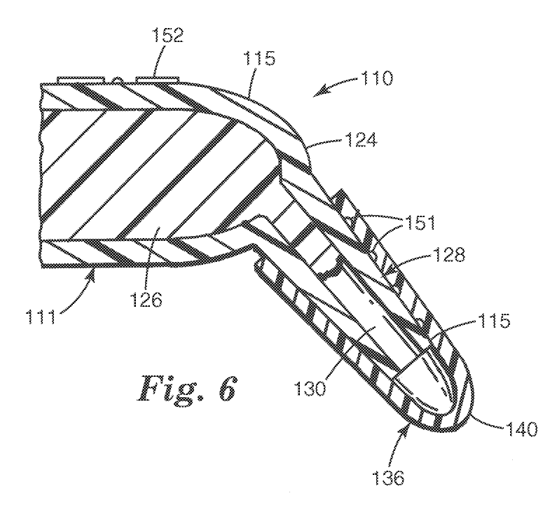

In one embodiment, exposure of one component part formed from a laser-enhanced polymer to laser radiation can be controlled to generate raised protrusions on that part. Those protrusions do not serve as indicia, but rather are used to facilitate engagement of that part with another part. For instance, with respect to a cartridge for dental material such as cartridge 110 illustrated in FIGS. 4, 5 and 6, a discharge end 124 of the cartridge 110 has a discharge nipple 128 thereon. The cartridge 110 is formed generally the same as the cartridge 10 illustrated in FIGS. 1-3, except that one or more raised protrusions 151 are disposed on an exterior surface 115 thereof (on the discharge nozzle 128). The protrusions 151 may take any form, such as bumps, ridges, spikes or lines (e.g., linear, wavy, dashed, etc.). In the illustrated embodiment of FIGS. 4, 5 and 6, four protrusions 151 are provided, in the form of four parallel lines which are evenly spaced along the length of the discharge nipple 128. In one embodiment, the protrusions 151 consist of four lines that are 0.25-mm wide and taper in length from 3.2 mm to 2.5 mm as the marks progress toward the end of the discharge nipple 128. The lines are perpendicular to a central axis of the orifice 130 and are evenly spaced (1.2 mm apart) along the length of the discharge nipple 128, thus extending part way around the exterior surface 115 on the discharge nipple 128. FIGS. 4 and 5 illustrate the discharge nipple 128 and its protrusions 151 without a removable cap thereon. In FIG. 6, a removable cap 136 is shown in place on the discharge nozzle 128 to form a seal for an enclosed dental composition 126 within a body 111 of the capsule 110.

The removable cap 136 is formed from a flexible material (e.g., Isoprene rubber, Abbot Laboratories, Chicago, Ill.) and is generally tubular in shape with a closed end 140. The cap 136 stretches as it is inserted onto the discharge nipple 128 to create an effective seal over the orifice 130, thereby closing off the dental composition 126 from ambient conditions. Providing one or more protrusions 151 on the exterior surface 115 of the discharge nipple 128 further enhances the frictional engagement between the cap 136 and the discharge nipple 128, by creating a designed discontinuity on the exterior surface 128 (which is otherwise smooth). The cap 136 resiliently expands over the exterior surface 115 and one or more protrusions 151 thereon to more positively couple the cap 136 to the discharge nipple 128, and thereby inhibit inadvertent separation of the cap 136 from the discharge nipple 128.

As illustrated in FIGS. 4, 5 and 6, a plurality of raised protrusions 151 is provided. The pattern and number of protrusions 151 may be provided in any selected arrangement, in order to enhance the coupling of the removable cap 136 and discharge nipple 128. In one embodiment, an inner surface of the removable cap 136 may be formed (e.g., with annular ribs or ribs) to even more positively engage the protrusions on the discharge nipple.

Each protrusion is formed by exposing a select portion of the exterior surface of the discharge nipple to laser generated radiation at an energy level sufficient to create a raised foamed discontinuity area (e.g., raised about 1.5 mil (0.04 mm)) in height from the exterior surface (in somewhat the same manner as discussed above with respect to the creation of indicia). However, as noted above, the raised protrusions are not formed for the purpose of identifying the characteristics of the dental composition stored within a particular cartridge, but for mechanical coupling purposes between the discharge nipple and its removable cap. In addition, one or more raised protrusions can be placed on a container (e.g., to extend above the cap thereon) to provide an automated vision system target that can be used to insure proper seating of the cap during production. The raised protrusions can be formed at the same time as the indicia are formed on the capsule (such as indicia 152 and 158 illustrated in FIGS. 4, 5 and 6). This ability to produce indicia and raised protrusions during a single laser radiation exposure of a capsule presents an efficient processing technique for improving the readability and functionality of a container. In one embodiment, after formation of the capsule, it is exposed to the laser generated radiation, capped (i.e., a cap is placed on the capsule's discharge nipple), filled with dental restorative material, and sealed (i.e., with a piston such as piston 20 in FIG. 2).

The present invention, in one form, represents a combination of laser-enhanced polymer technology, laser processing, and polymer based packaging for radiation-reactive dental restorative materials. The invention presents a much more cost effective means for marking containers than pad printing and thermal transfer printing, and a more visually and optically effective means for marking such containers. In addition, laser marking enables significant flexibility for the production of markings on containers, both in terms of the information being marked, and in terms of production lead times and set up costs. Further, it is contemplated that laser markings can be designed in a manner to provide deterrents to grey marketing without incurring additional manufacturing costs. For example, markings can be produced in local or regional languages, thereby permitting the production of containers intended exclusively for certain markets or regions. Likewise, the flexibility of laser marking allows the tailoring of the marking on a container to specific customer requests or specific marketing goals, simply because of the ease of changing the laser markings from container to container. An additional benefit from more effective container marketing is the elimination (or at least reduction) of unit packaging. Additional information can be placed on the product container itself, at no additional cost, and thus additional unit packaging can be eliminated with the containers packaged for transport and storage in bulk.

The examples presented below are intended to illustrate the invention. They are not intended to limit the invention.

### EXAMPLES

### Example 1

Polymeric capsules (i.e., cartridge) designed to hold radiation-reactive dental restorative materials were produced from different laser-enhanced (LE) polymers using conventional injection molding techniques. The capsules were black in color, tubular in shape with a tapered nozzle (i.e., discharge nipple) at one end, and had an interior chamber. The capsules were 2.3-cm long×6.6-mm outside diameter with a 4.0-mm inside diameter and have been previously described, e.g., in U. S. Pat. No. 5,624,260 (Wilcox et al.). Alternatively, for evaluation purposes, rectangular or dog bone-shaped test articles were injection molded from various LE polymers.

The outer surface of the polymeric capsules or test articles were marked with an Nd:YAG laser (YAG laser engraving system sold under the brand name “Hi-Mark” No. 400 from GSI Lumonics, Inc., Kanata, Ontario, Canada) using specific marking speed, laser power and frequency of laser pulse process parameters. The marks appeared as white, and typical markings included, for example, lot code consisting of two alphanumeric characters, expiration date consisting of an hour glass symbol and the two-digit year and two-digit month, product identity (e.g., Z250, Z100, A110, F2000, Supreme, Unitek), shade identifier comprising up to 4 digits alphanumeric, and corporate identify marks (e.g., 3M ESPE). Table 1 provides a list of different LE polymers utilized to make the capsules or test articles, the process parameters, and the general appearance of the laser markings. Comparison is made to a capsule injection molded from a conventional polymer, i.e., not a LE polymer.

TABLE 1

| | Laser Process Parameters | | | |
|---|---|---|---|---|
| Polymer | | Power | | |
| (Product Number, | | Watts (W) | Freq. | Marking |
| Description, and Source) | Speed (mm/sec) | and % | (kHz) | Observations |
| RTP LE Polymer | 480 | 22 W | 2500 | Molded black |
| (Product No. RTP 0299 × | | 83% | | capsules marked |
| 102892 SSL-801191; nylon | | | | with laser; good |
| 6/6 base resin; carbon black) | | | | contrast of white |
| (RTP Company, Winona, | | | | indicia with |
| MN) | | | | background |
| Clariant LE Polymer | 395 | 5 W | 3000 | Molded black test |
| (Product No. 00025275; | | 21% | | articles (4.8 × 8.0 |
| nylon 6/6 base resin; carbon | | | | cm; 2.5 mm thick) |
| black) | | | | marked with laser; |
| (Clariant Masterbatches | | | | good contrast of |
| Div., Albion, MI) | | | | white indicia with |
| | | | | background |
| PolyOne LE Polymer | 489 | 1 W | 4000 | Molded black test |
| (Product No. | | 5% | | articles (6.1 × 8.4 |
| CC10041306WE; nylon 6/6 | | | | cm; 1.3 mm thick) |
| base resin; carbon black) | | | | marked with laser; |
| (PolyOne Corp., Suwanee, | | | | good contrast of |
| GA) | | | | white indicia with |
| | | | | background |
| Ticona LE Polymer | 395 | 8 W | 6000 | Molded black test |
| (Product No. 1000-2LM | | 29% | | articles (5.9 × 8.4 |
| ND3650; nylon 6/6 base | | | | cm; 2.5 mm thick) |
| resin; carbon black) | | | | marked with laser; |
| (Ticona, Summit, NJ) | | | | good contrast of |
| | | | | white indicia with |
| | | | | background |
| BASF LE Polymer | 125 | 9 W | 1000 | Molded black test |
| (ULTRAMID B3K LS | | 33% | | articles (21.6 × 1.9 |
| Black 23189; Product No. | | | | cm dog bone-shaped |
| NPP TN020327; nylon 6/6 | | | | with a 1.3 × 6.4 cm |
| base resin; carbon black) | | | | narrow center |
| (BASF Corp., Performance | | | | section; 2.5 mm |
| Polymers, Mt. Olive, NJ) | | | | thick) marked with |
| | | | | laser; good contrast |
| | | | | of white indicia with |
| | | | | background |
| Conventional Polymer (Not | 1200 | 8 W | 1500 | Molded black |
| LE) Blend of ZYTEL 101L | | 30% | 0 | capsules marked |
| Nylon 6/6 (from Dupont) | | | | with laser; poor |
| and 4% Black Colorant | | | | contrast of gray |
| M.A. Hanna 470556-LMB | | | | indicia with |
| (from PolyOne) | | | | background |

General Observations:

In the case of capsules or test articles injection molded from the LE polymers, the laser radiation produced bright white markings which were in sharp contrast to the black capsule or article surfaces. The markings resulted from “foaming” the top surface of the capsules and were typically about 1.5 mil (0.04 mm) in height. Thus, the markings provided a tactile, less slippery feel to the capsule surface.

In the case of capsules that were injection molded from the conventional nylon-based polymer (non LE polymer), the laser radiation produced gray-colored markings which had significantly less contrast to the black capsule surface than the white laser markings on the capsules and articles made from the LE polymers. The markings on the capsules made from the conventional polymer appeared to be engraved (and recessed approximately 1 mil (0.025 mm) below the capsule surface) and not “foamed” or raised in height from the capsule surface.

It is also noted that the process parameters of marking speed and frequency of laser pulse were significantly greater for the capsules made from the conventional polymer. Because it is necessary to “engrave” conventional polymers using higher radiation power settings, increasing the pulse frequency of the laser beam is required. Once the effective power is increased to the required level for engraving, the resolution of the characters is controlled by the speed of the laser.

Some of the capsules made from the RTP LE polymer were subsequently filled with a radiation-reactive (i.e., curable) dental material (e.g., Z100 Restorative, Filtek Z250 Universal Restorative, or Filtek Supreme Universal Restorative, all available from 3M Company) and the capsules subjected to a variety of compatibility, toxicological, and shelf-stability evaluations. The results of these evaluations indicated that the capsules made from LE polymers, laser marked with indicia, and filled with radiation-reactive dental materials showed good compatibility, favorable toxicity, and shelf-stability durations comparable to filled capsules made from the conventional nylon polymer (non-LE polymer).

Evaluation of Marking Contrast:

As generally described herein, capsules were injected molded from the RTP LE Polymer (see Table 1), laser-marked with the indicia “A3 Z250” using the laser process parameters provided in Table 1, and designated “LE Capsules”. For comparison, capsules were injected molded from the ZYTEL Conventional Polymer (see Table 1), laser-marked with the indicia “CG CJ” using the laser process parameters provided in Table 1, and designated “Conventional Capsules”. For both the LE Capsules and the Conventional Capsules, the brightness contrast of the indicia in comparison with the black capsule surface was determined by the following Scanning Test Method:

LE Capsules and Conventional Capsules were placed together on a PC scanner (EPSON Perfection 636, Epson, Long Beach, Calif.) with indicia facing the scanned side and scanned with 600 dots per inch (dpi) resolution. The scanned image was imported into Adobe Photoshop Software (Version 7) (Adobe Systems, San Jose, Calif.) for image analysis. To measure background brightness, a 3.5 mm×0.5 mm rectangular area of a representative section of each capsule black surface was selected. A histogram was performed according to the Adobe Photoshop program in order to obtain a luminosity value, a standard deviation, and a pixel value. To measure indicia brightness, a 0.5 mm×0.1 mm rectangular area of a representative section of each capsule indicia was selected and the same histogram analysis was utilized. The exact same image analysis was performed on LE Capsules and Conventional Capsules and the results are reported in Table 2. A Brightness Scaled Contrast number was then calculated according to the following formula and represented a relative indication of brightness contrast between the laser-generated indicia and the black background surface of the capsules:
Brightness Scaled Contrast=(Luminosity/Indicia−Luminosity/Background)×(Luminosity/Indicia)−(Luminosity/Indicia+Luminosity/Background)

TABLE 2

| | |
|---|---|
| Conventional | |
| Capsules | LE Capsule |

| | Background | Indicia | Background | Indicia |
|---|---|---|---|---|
| Luminosity Mean | 27.86 | 86 | 21.79 | 210.39 |
| Standard Deviation | 5.35 | 12.91 | 6.66 | 18.34 |
| Pixel | 1826 | 33 | 1826 | 33 |

| | | |
|---|---|---|
| Brightness Scaled | 44 | 171 |
| Contrast | | |

The calculated Brightness Scaled Contrast values reported in Table 2 suggest that the brightness contrast of the laser-marked indicia on the LE Capsules was nearly four times the brightness contrast of the laser-marked indicia on the Conventional Capsules.

1-20. (canceled)

21. A method of forming a capsule assembly for a dental material, comprising the steps of:
(a) providing a container having an exterior surface and an interior chamber, the container formed from a laser-enhanced polymer and adapted to inhibit the transmission of light radiation of selected wavelengths therethrough; and
(b) exposing selected portions of the exterior surface of the container to laser-generated radiation at an energy level sufficient to cause foaming of the laser-enhanced polymer to create raised indicia on the exterior surface, the indicia having a sufficient contrast relative to the exterior surface to enable visual human and/or optical mnachine-readable detection of the indicia.

22. The method of claim 21, further including the step of inserting radiation-reactive dental restorative material into the interior chamber of the container.

23. The method of claim 22, wherein the indicia identify characteristics of the dental material.

24. The method of claim 22, wherein the laser-enhanced polymer forming the container is inert relative to the dental material.

25. The method of claim 21, wherein the ability of the container to dispense dental material under pressure is not adversely affected by the exposure of the container to laser-generated radiation when creating the indicia on the exterior surface of the container.

26. The method of claim 21 wherein the indicia include an optically machine-readable bar code.

27. The method of claim 21 wherein the indicia include letters, numerals, symbols optically machine-readable bar codes, or reverse images thereof.

28. The method of claim 21 wherein step (b) comprises activating an Nd:YAG laser.

29. The method of claim 21 wherein step (a) comprises providing a black container.

30. The method of claim 21, wherein the selected wavelengths are from 370 nm to 530 nm.

31. The method of claim 21 wherein the indicia contrast has a Brightness Scaled Contrast of at least 50.

32. The method of claim 21, and further comprising:
providing a plurality of containers according to step (a); and
exposing portions of the exterior surfaces of each of the containers in the plurality of containers to the laser-generated radiation during a single pass to create the indicia on each container.

33. The method of claim 32, wherein the method further comprises the step of providing different indicia on different ones of the containers in a single pass of the laser-generated radiation.

34. The method of claim 21, wherein the indicia is raised relative to the exterior surface of the container sufficient to readily enable manual tactile detection thereof.

35. The method of claim 21 wherein the container has a discharge nipple extending therefrom, and wherein the method further comprises creating a raised protrusion on an exterior surface of the discharge nipple as a result of exposure to laser-generated radiation.

36. The method of claim 35, wherein a plurality of raised protrusions are formed on the exterior surface of the discharge nipple.

37. The method of claim 35 wherein the creation of the indicia and the protrusion occur during a single pass of laser-generated radiation across the container.

38. The method of claim 35, and further comprising;
mounting a flexible cap over the discharge nipple so that portions of the cap stretch to -fit over the discharge nipple and the raised protrusion.

39. The method of claim 21, wherein the indicia is raised about 0.04 mm in height from the exterior surface.

40. The method of claim 21, wherein the indicia enable manual tactile detection,
